(19) United States
(12) Patent Application Publication
(10) Pub. No.: US 2012/0192493 A1
(43) Pub. Date: Aug. 2, 2012

(54) AUTOMATED STRIKE

(76) Inventor: JEFFREY A. WOLFE, MATTHEWS, NC (US)

(21) Appl. No.: 13/016,031

(22) Filed: Jan. 28, 2011

(51) Int. Cl. E05B 15/02; E06B 3/46

(52) U.S. Cl. 49/449; 292/340; 292/341.19

(57) ABSTRACT

The present invention relates to the field of doors and more particularly to an automated strike assembly for a sliding door. In particular, it relates to an automatically operable strike, which functions with existing manual latches. When using the automated strike, an engaged latch may be released by automatically sliding the entire strike plate over the latch hook. The automated strike comprises a strike plate adapted to engage with a latch, mounting means for slidably attaching the strike plate to a door jamb and driving means adapted to receive a control signal and to slide the strike plate between a latched position and an unlatched position. The invention also relates to a method for unlatching a door using the automated strike.

### TECHNICAL FIELD

The present invention relates to the field of doors and more particularly to an automated strike assembly for a sliding door. The invention also relates to a method for latching and unlatching a sliding door using the automated strike.

### BACKGROUND

Sliding doors are commonly used in commercial, healthcare, and residential applications. The sliding doors may be manual or automatic. There are a variety of requirements that dictate what types of doors can be used in specific settings, which directly affect door package design and offerings thereof. Some examples of such requirements include building codes, safety codes, customer requirements, or other various types of code requirements. This is particularly true for hospital environments, such as intensive care units (ICUs) or critical care units (CCUs), in which an increase of requirements has recently been seen.

A requirement on an ICU door may be that the door is trackless, that is, the door does not have any threshold or similar arrangement across the door opening, so as to minimize collection of bacteria and various types of debris, and such that patients and ICU equipment can be easily moved through the door opening. Another requirement may be that the door should have a UL air leakage rated seal around its perimeter, in order to create a seal that serves to minimize germ contamination inside the room by reducing air leakage and infiltration.

Furthermore, an ICU door may be required to have a positive latch e.g. as specified by Underwriters Laboratories standard 1784 (UL 1784) leakage rating. This implies that the door should be possible to secure to the door jamb, so that the door cannot open by itself after the door has been closed, i.e. even in a power failure the door must remain latched. It is also required to have a handle that protrudes from the door face, that is, so-called flush pull or finger pull handles are not acceptable.

Today there exist several types of latches for sliding doors on the market. A typical solution to achieve a positive latch function is to use a pivoting latch hook, which protrudes through a central aperture in a strike plate attached to the door jamb. The latch hook typically engages with the backside of a strike plate, and may be arranged with a lever attached to a handle or knob. Thereby the user may release the latch by pressing or rotating the handle.

Another example of a manual latch for a sliding door according to prior art, is a double or single acting lever bolt, i.e. a lever mounted on the face of the door that actuates rods inside the door panel connected to bolts that lock the door to the floor or door stile.

However, the requirement of having a positive latch implies a problem when automating an ICU door package. The manual door mechanically locks via the lever latch every time the door is closed. Hence, for an automated ICU door the manual function of the latch, i.e. the positive latching, must be maintained at the same time as automatic opening is enabled.

Hence, what is desired is a latch that may be operated automatically, and at the same time fulfils the requirement on positive latch function. Further desired is a latch function that can be operated both manually and automatically, i.e. operable without manual interaction. In manual mode, a person turns the lever and disengages the latch, but when automating the ICU door, one does not want the customer to be required to touch the lever or door in any way.

### SUMMARY OF THE INVENTION

With the above description in mind, then, an aspect of the present invention is to provide a method and a latch, which seeks to mitigate, alleviate, or eliminate one or more of the above-identified deficiencies in the art and disadvantages singly or in any combination.

According to at least one embodiment of the invention, an automatic latch function that overcomes the above-mentioned problems is provided by using an automatically operable strike, which functions with existing manual latches. When using the automated strike, an engaged latch may be released by automatically sliding the entire strike plate over the latch hook.

According to one aspect of the invention, it provides for an automated strike for a sliding door system comprising:
a strike plate adapted to engage with a latch,
mounting means for slidably attaching the strike plate to a door jamb and
driving means adapted to receive a control signal and to slide the strike plate between a first position and a second position.

In other embodiments, the invention relates to an automated strike for a sliding door system comprising a strike plate, adapted to engage with a latch, mounting means, adapted to slidably attach the strike plate to a door jamb and driving means adapted to receive a control signal and to slide the strike plate between a first position and a second position.

In another embodiment, the driving means is adapted to slide the strike plate between three or more positions.

In another embodiment, the first position of the strike plate corresponds to a latched position and the second position of the strike plate corresponds to an unlatched position.

In another embodiment, the strike plate comprises an aperture for receiving the latch.

In another embodiment, the mounting means comprises a back plate.

In another embodiment, the back plate comprises height adjustment means adapted to height adjust the automated strike in relation to the door jamb.

In another embodiment, the driving means may be a solenoid, a pneumatic cylinder, or a spring.

According to aspects of the invention, a method is provided for unlatching a sliding door comprising a latch and a strike plate comprising the steps of receiving a signal to unlatch the door and activating driving means to slide the strike plate and sliding the strike plate from a first position corresponding to a latched position to a second position corresponding to an unlatched position.

In another embodiment, the method for unlatching a sliding door further comprises sliding the strike to a third position.

In another embodiment, sliding the strike plate involves sliding an edge of an aperture in the strike plate over the latch.

In another embodiment, the method for unlatching a sliding door comprises driving the door in the closing direction to remove any pressure on the latch.

In another embodiment, the invention comprises an automatic door package comprising a strike plate.

In another embodiment, the invention comprises an automation kit for automating a manual sliding door package comprising a strike plate.

One way to release the latch is provided, which will allow the door to then open on its own without any obstruction or human intervention and still keep the positive latch function.

Furthermore, an automated latch function is achieved, which is compatible with an existing manual latches.

This further implies that the positive latch function of the manual doors is kept, which may be a requirement in healthcare environments. Hence, the door will remain latched even at a power failure. As the automated strike works with a manual latch, a latched door may however be opened manually at a power failure.

The automated strike enables the automating of ICU doors where a positive latch function is required. This provides several advantages in a hospital, when a fast opening of the door is required e.g. due to an emergency message such as a “life alert” or a fire alarm, when valuable life saving seconds are lost when sliding the door out of the way.

The compatibility with existing manual latches is also advantageous when retrofitting automation kits of existing manual doors, as the number of components that needs to be exchanged is minimized.

### BRIEF DESCRIPTION OF THE DRAWINGS

Further objects and features, of the present invention will appear from the following detailed description of embodiments of the invention, wherein the embodiments will be described in more detail with reference to the accompanying drawings, in which:

FIG. 1 illustrates a manual ICU door package according to prior art.

FIGS. 2a to 2d illustrate a manual latch and a flush mounted strike plate according to prior art.

FIG. 3 illustrates an automatic ICU door package.

FIGS. 4a to 4c illustrate an automatically operated strike plate.

FIGS. 5a and 5b illustrate an automatically operated strike plate, when mounted in a door package.

FIG. 6 illustrates a method for unlatching a door using the automatically operated strike plate in a flow chart.

FIGS. 7a to 7c shows unlatching of a door using an automatically operated strike plate.

It should be added, that the following description of the embodiments is for illustration purposes only and should not be interpreted as limiting the invention exclusively to these embodiments/aspects.

### DETAILED DESCRIPTION

Embodiments of the present invention relate to an automated strike. The invention also relates to a method for engaging and releasing a latch.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

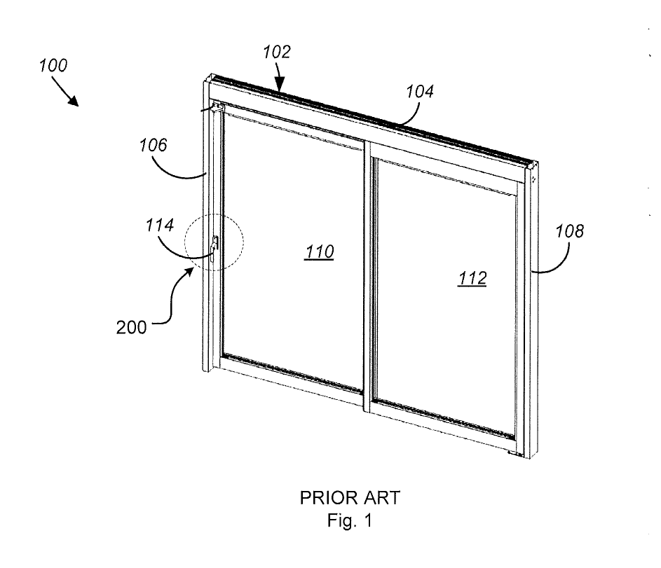

FIG. 1 shows a manual ICU door package 100 according to prior art. As can be seen in FIG. 1, the door package 100 includes a frame 102 that has a top portion 104, a left jamb 106 and a right jamb 108. The frame 102 can be made of any conventional material that is used for manufacturing doorframes, as is well known to those of ordinary skill in the art.

Inside the frame 102 is a door with two door panels; a left door panel 110 and a right door panel 112. This type of door is often referred to as a two-panel single slider package. It should be noted that while FIG. 1 shows two door panels, in some embodiments the door can be a so-called telescopic door, that is, a door containing three (or more) door panels. In fact, for some applications a three-panel telescopic door may actually be more desirable than a two-panel slider, as the three-panel telescopic door offers a larger clear door opening (CDO) compared to a two-panel slider for a door package of the same size. In the illustrated embodiment, the left door panel 110 can slide behind the right door panel 112 along tracks that are located in the top portion 104 of the frame 102. Of course, as the skilled person realizes, depending on different embodiments, the door package 100 can also be configured such that the right door panel 112 slides behind the left door panel 110. It should further be noted, that there are no tracks on the floor in which the left door panel 110 can slide. That is, the door package (100) is a trackless door package 100. However, the invention could as well be implemented on a door with tracks or wheels or any combination thereof.

Attached to the left door panel 110 is a latch 200 that can positively latch into the left jamb 106. The latch handle 114 protrudes from either side of the left door panel 110 and can be gripped by a person and rotated slightly to unlatch the left panel 110 from the left jamb 106. While holding the handle 114, the person can slide the left panel 110 behind the right panel 112 to achieve a maximum clear door opening (CDO) of the door in relation to its package size.

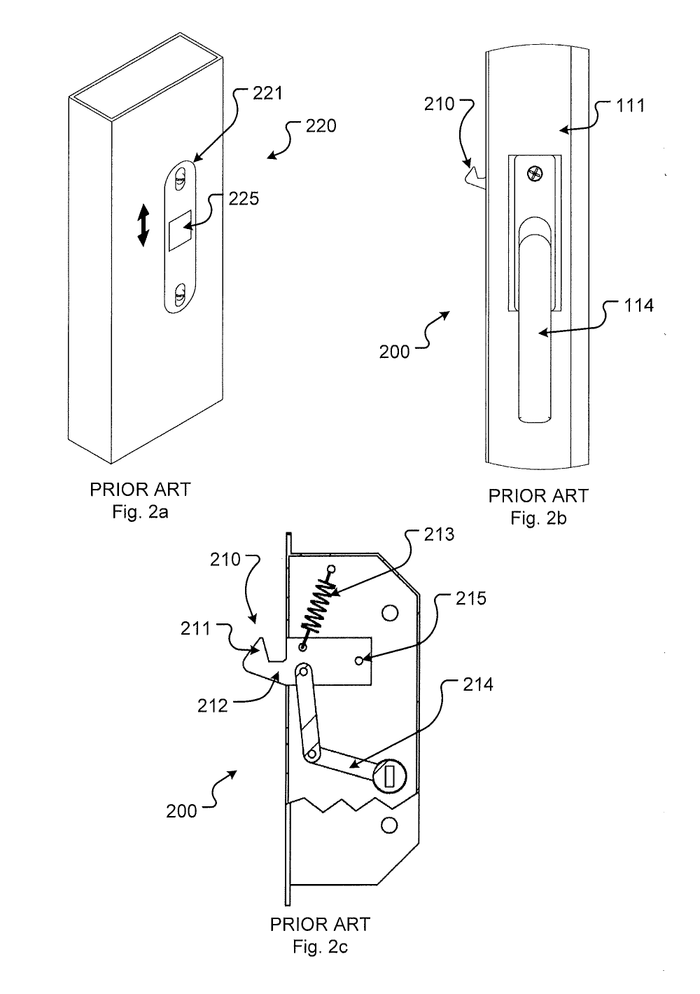

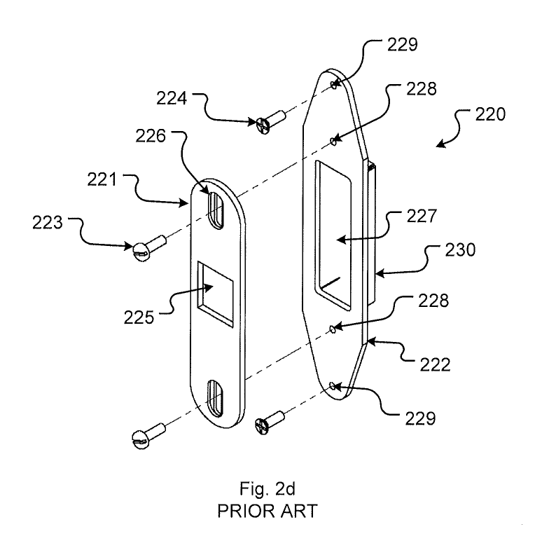

FIG. 2a and FIG. 2b illustrate a flush or surface mounted strike plate 220 and a manual latch 200, according to prior art.

FIG. 2a illustrates a strike plate 221 attached to a tube shaped left jamb 106. The strike plate 221 is flush mounted i.e. has the strike plate 221 flush with the surface of the door jamb 106. How this is achieved is further described below, in relation to FIG. 2c. The strike plate 221 is adjustable in a vertical direction for alignment of a central aperture 225 with the latch hook 210, described in FIG. 2b.

FIG. 2b shows a latch 200 for a manual sliding door. The latch 200 comprises an L-shaped latch hook 210 and a handle 114. FIG. 2c shows the latch 200 attached to a door panel 110 in more detail. The latch 200 comprises a latch hook 210, a lever 214, a spring 213 and a handle 214, see FIG. 2b. The latch hook 210 has a horizontal limb 212, having an outer end extending outside the door stile. The inner end of the horizontal limb 210 is rotatably attached to the door stile 111 at a connection point 215. The latch hook also has a vertical limb 211 extending upwards from the outer end of a horizontal limb 212.

The lever 214 transfers movement from the handle 114 to the latch hook 210. The spring 213 is adapted to apply a spring force on latch hook 211 in a vertical direction.

The latch hook 210 is adapted to engage with a strike plate assembly 220, shown in FIG. 2a, when the door 110 is closed. When closing the door 100, the latch hook 210 hits the strike plate 221 and is forced downward through the central aperture 225 in the strike plate 221. Once the latch hook 210 clears the hole, the spring 213 pulls it upwards and the vertical limb 211 engages with the back side of the strike plate 221. The back side refers to the side facing the door jamb 106.

The latch hook 210 can be disengaged from the strike plate 221 manually by rotating the latch handle 114 and thereby moving the latch hook 210 downwards, such that the vertical limb 211 can move under the upper edge of the central aperture 225.

FIG. 2d shows the strike plate assembly 220 comprising the flush mounted strike plate, shown in FIG. 2a, in more detail. The assembly comprises a strike plate 221 and a back plate 222 and two sets of screws 223, 224. The strike plate 221 has a central aperture 225 and two vertical slots 226, one on each end. The back plate 222 also has a central aperture 227 covered by a dust cover 230 and holes 228, 229.

For achieving the flush mount, there is a cut-out in the jamb tube. When mounted, the back plate 222 is placed inside the door jamb 106 and the strike plate 221 is placed outside the door jamb 106, on the side facing the door panel 110. At mounting, the strike plate 220 is height adjusted such that the latch hook 210 is aligned for engagement with the central aperture 225 of the strike plate 221.

The first set of screws 223 is used for fixing the strike plate 221 to the back plate 222 in a vertical direction, after alignment with the latch hook 211.

The screws are attached into the holes 228. The second set of screws 224 is used for fixing the back plate 222 to the door jamb 106 via the holes 229.

As mentioned before it may be desired to operate a door, such as the ICU door 100 described in FIG. 1 automatically i.e. without using manual force.

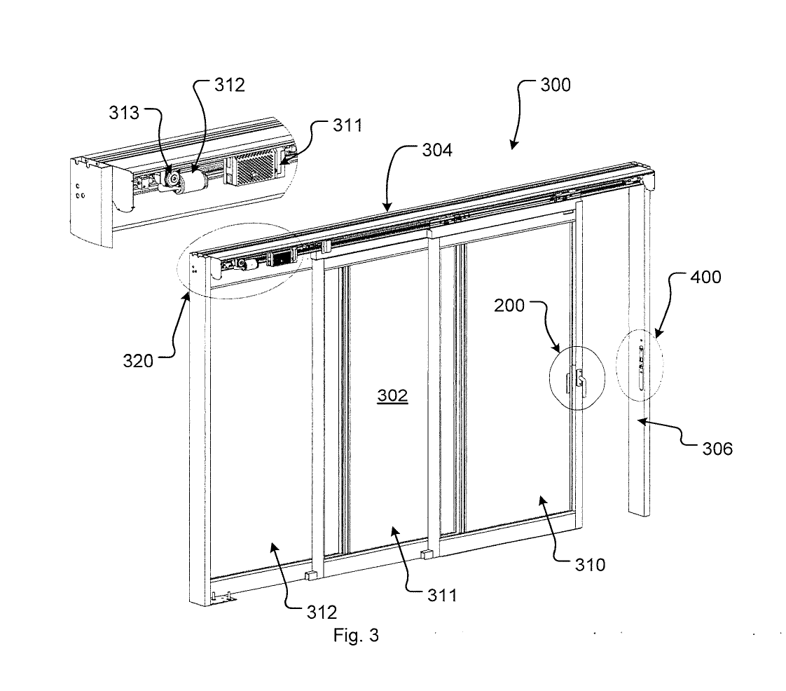

FIG. 3 shows an overview of an automatic ICU door package 300. The door package 300 comprises a door 302 comprising three door panels, a left door panel 312, a middle door panel 311 and a right door panel 310. Attached to the right door panel 310 is a latch 200 that can positively latch into the right jamb 306. The automatic ICU door package 300 is constructed in the same manner as the manual ICU door package described in relation to FIG. 1 except for the difference that an automation kit is installed. An automation kit may be installed in the factory. An automation kit may also be retrofitted to an already installed door.

The automation kit comprises e.g. a door controller 313, an automated strike 300 and drive means 320.

The door controller 313 controls the operation of the automatic ICU door package 300, based on received signals.

The drive means 220 is located in the top portion 204 of the frame and comprises a tooth belt and a drive wheel, not visible, a gear box 223 and an electrical motor 222. The drive means 220 are adapted to open and close the door 202. Drive means, like wheel and belt drive, are commonly known within the art and are therefore not described in further detail.

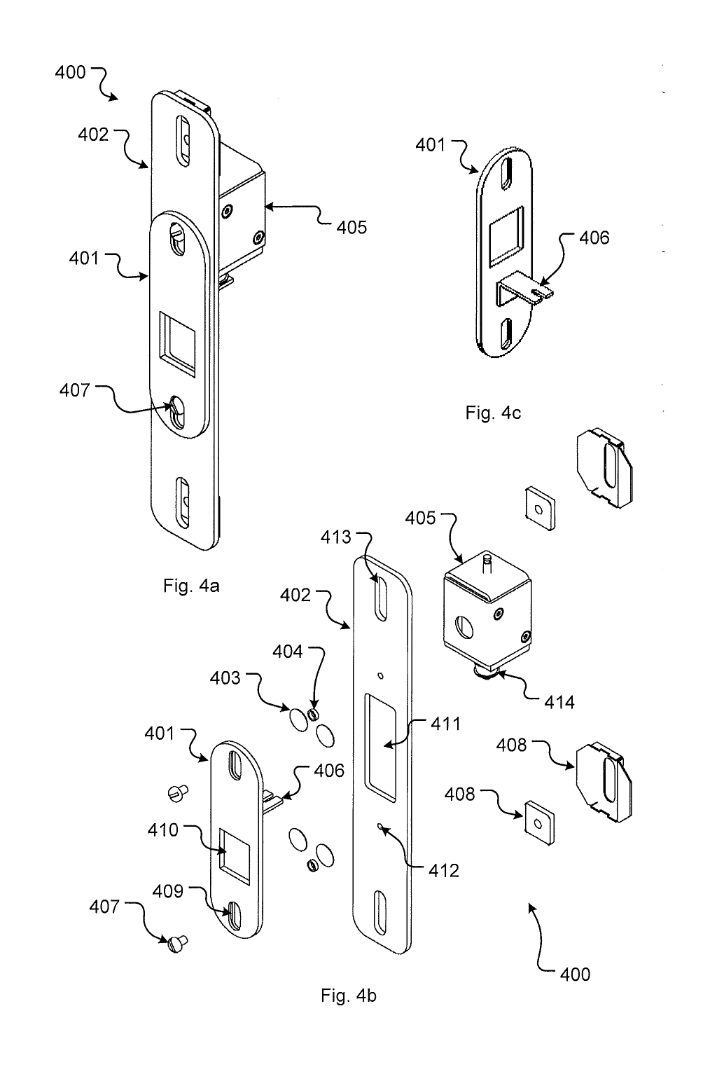

Due to the requirement on the ICU door to have a positive latch function, an automatic ICU door requires a latch, which may be operated both manually and automatically. Automatic operation refers to operation without ‘ applying any manual force to release the latch. The automated strike 300 operates together with the manual latch 200, which is identical to the latch 150 shown in FIG. 2b. The automated strike 300 enables automatic operation of the latch 200. The automated strike is described in detail in FIGS. 4a to 4c.

FIGS. 4a and 4b disclose the strike assembly 400, which allows a sliding door to function both in a manual mode and in an automatic mode. The strike assembly 400 may cooperate with the latch 200 described in FIG. 2b. The strike assembly 400 will now be described in more detail in particular referring to FIGS. 4a and 4b.

The strike assembly 400 comprises a strike plate 401, a back plate 402, plastic discs 403, a strike spacer 404, a solenoid assembly 405, a strike connector 406, mounting screws 407 and mounting plates 408.

The strike plate 401 is an oblong flat piece made of e.g. metal. The strike plate is shown from the back in FIG. 4c. The strike plate has a central aperture 410. The strike plate has two slots 409 extending along the oblong strike plate 401. The slots are adapted to mount the strike plate 401 to a back plate 402. The slots 409 are positioned one at each end portion of the strike plate 401, with the central aperture 410 in between. The slots 409 in the strike plate 401 are arranged to allow the automatic movement up/down of the strike plate 401 in relation to the back plate 402. These slots 409 may e.g. be 6.4×17.4 mm with a 8.4×17.4×1.5 mm counter bore to accommodate a strike spacer 404 and screws 407 e.g. M4 pan head machine screws, that fastens the strike plate 401 to the back plate 402.

The back plate 402 is also an oblong flat piece of e.g. metal. The back plate 402 has a central aperture 411, two holes 412, and two slots 413. The slots 413 are adapted to mount the strike plate 401 to the door jamb 206. A door jamb could be any opposing part of the latch 200. The slots extend along the back plate 402 to allow for adjustment of the entire strike assembly 400 to correspond with the vertical position of the door 302. The holes 412 are adapted to receive the screws 407. The mounting plates 408 are used for mounting the back plate 402 to the door jamb 206.

The strike connector 406 is a piece of metal extending perpendicularly from the strike plate 401 towards the back plate 402 and through the central aperture 411 of the back plate 402. The strike connector is adapted to be connected to a core 414, which cooperates with a solenoid, not shown in order to move the strike plate 401. The strike connector 406 is attached to the strike plate 401 by welding. It may also be bonded or attached with screws; in this embodiment, welding is preferred to achieve the design goal of eliminating exposed fasteners.

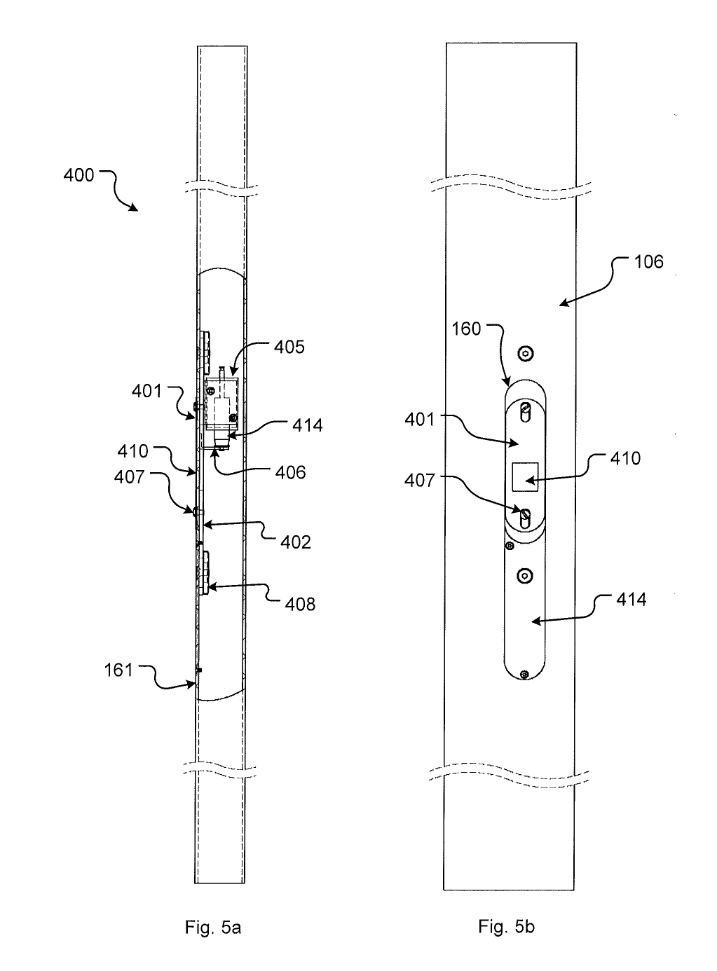

The strike assembly 400 shall be mounted with the back plate 402 inside the door jamb 206 and the strike plate 401 outside the door jamb 206 on the side of the door jamb facing the door panel 110. Mounting is further described in relation to FIGS. 5a and 5b.

In contrast to the strike assembly disclosed in FIGS. 2a, the strike plate 401 is slidably attached to the back plate 402. Hence, when mounted, the strike plate 401 may be slided in a vertical direction in order to disengage the latch hook 210.

Between the strike plate 401 and the back plate 402, there are plastic discs 403 and strike spacers 404. The strike spacers 404 provides for a distance between the strike plate 401 and the back plate 402, when mounted. The plastic discs 403 are e.g., 4 self-adhesive UHMW discs 12.7 mm diameter×0.012 thickness, to prevent noise and reduce friction, when sliding the strike plate 401. The same result may be accomplished using grease or some type of bearing.

The solenoid assembly 405 comprises a solenoid, not shown and a core 414 positioned inside the solenoid. The solenoid and core 414 is used to move the strike plate 401 automatically in a vertical direction. The solenoid assembly 405 is attached to the backside of the back plate 402, i.e. inside the door jamb 206. Thereby, the core 414 is positioned right above the strike connector 406, such that it can be connected to the strike connector. The solenoid is activated by a 12 VDC current supplied from an external power source, not shown. When the solenoid is activated, the core moves in a vertical direction, due to the magnetic field created by the solenoid.

The solenoid assembly 405 may have an extra cover on the bottom side to be able to remove the unit so the solenoid can be replaced.

FIG. 5a discloses a cross-section of the strike assembly disclosed in FIG. 4, mounted in a tube shaped door jamb 206. FIG. 5b discloses the strike assembly disclosed in FIG. 4, seen from above. The flush mounting will now be described in more detail referring to FIGS. 5a and 5b. The door jamb 206 has a cut out hole 160, that is 0.5 mm wider than the strike plate 401 and long enough for installing or removing the entire assembly through the hole 160. The back plate 402 is mounted against the inside of the jamb tube wall 161, which will make the strike plate relatively flush. There is also an auxiliary cover 414, which is needed since the cut-out 160 is longer than the hole needed for the strike plate 401. The strike plate 401 and cover 414 will protrude about 1 mm from the jamb tube surface due to thicknesses of the materials and the way the cover fastens.

The strike assembly 400 disclosed in FIGS. 4 and 5 may be operated both manually and automatically. In the manual mode, the latch hook 211 can be disengaged from the strike plate 401 by rotating the latch handle 214 and thereby moving the latch hook 210 downwards, such that the vertical limb 211 of the latch hook 210 can move under the upper edge of the central aperture 310. Thereby the door is unlatched.

In the automatic mode, the latch assembly 400 may be released by sliding the strike plate 401 over the latch hook 201. This is possible as the strike plate 401 is slidable in a vertical direction in relation to the back plate 402 and because the strike assembly comprises driving means for driving the strike plate.

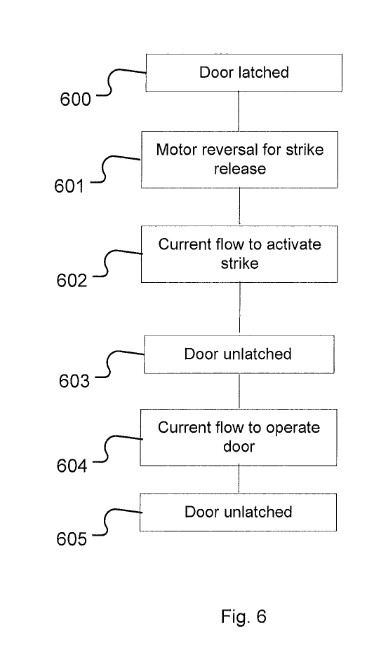

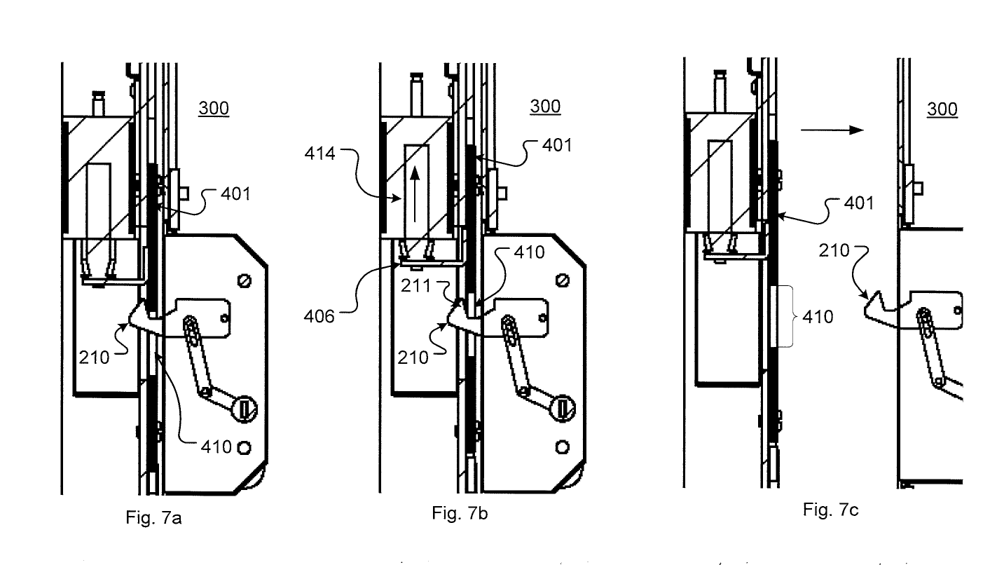

As the back plate is fixed mounted to the door jamb 206, the strike plate 401 is slidable in relation to the door jamb 206 and to the latch hook 210 as well. FIG. 6 illustrates the automatic mode in a flow chart. FIG. 7 shows how the latch is released using the automated strike.

Before the opening starts, the door is positively latched 600. This is disclosed in FIG. 7a. When the door 302 is latched, the latch hook 210 is positioned in the central aperture 410. The spring 213 pulls the latch hook 210 upwards and the vertical limb 211 engages with the back side of the strike plate 401. Thereby the latch is locked.

When the controller receives a signal to open the door, the drive motor briefly (milliseconds) runs in the reverse (closing) direction to remove any pressure on the latch 200, step 601. Thereafter, a current is applied to the solenoid operating as an electromagnet, step 602. The current is e.g. a 12 VDC current supplied from an external power source. The current moves the core 414 upwards, whereby the strike connector 406 and the entire strike plate 401 also moves upwards. When the strike plate 401 is moved upwards, such that the vertical limb 211 can move under the upper edge of the central aperture 410 of the strike plate, the door in unlatched, step 603. FIG. 7b shows the unlatched door.

Thereafter, the door is opened by letting a current flow through the motor 312. FIG. 7c shows the opened door, step 605.

The door may also be latched either manually or automatically. In manual mode, when the door is moved to its closed position, the latch hook 210 hits the strike plate 401, and is forced downwards through the central aperture 410 in the strike plate 401. Once the latch hook 210 clears the hole, the spring 213 pulls it upwards and the vertical limb 211 engages with the back side of the strike plate 401.

In automatic mode, the strike plate 401 stays in its unlatched position during the entire cycle. When the door 302 has reached its closed position, the power to the solenoid is dropped and the strike plate 401 slides over the latch hook 210. Thereby, the vertical limb 211 engages with the back side of the strike plate 401.

Using a solenoid is just one example of a driving means for creating the motion of the strike plate. Other options are e.g. hydraulic or oil actuated cylinders, linear actuators, elastic tension devices or other action or device that causes the strike to move in a manner that releases or captures the latch.

The automated strike described above enables an automatically operated latch function. This solution does not require any modification of the latch 200. Hence, the latch 200 is the same as disclosed in FIG. 2b. Thereby the automated strike may be used on a manual sliding door, e.g. when retrofitting an automation kit on an existing ICU door. Thereby, an ICU door may be made automatic, by adding a drive kit to the door header, as disclosed in FIG. 3 and simply exchanging the strike assembly.

It must also be understood, that the use of the automated strike plate is not limited to healthcare environments. The automated strike may be used' in any door; there a positive latch function is desired. The invention is not limited to overhead sliding doors, but can be used on all sliding doors.

The foregoing has described the principles, preferred embodiments, and modes of operation of the present invention. However, the description should be regarded as illustrative rather than restrictive, and the invention should not be limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

What is claimed is:

1. An automated strike for a sliding door system comprising:
a. a strike plate, adapted to engage with a latch;
b. mounting means, adapted to slidably attach the strike plate to a door jamb; and,
c. driving means adapted to receive a control signal and to slide the strike plate between a first position and a second position.

2. An automated strike according to claim 1, wherein the driving means are further adapted to slide the strike plate between three or more positions.

3. An automated strike according to claim 1, wherein the first position corresponds to a latched position and the second position corresponds to an unlatched position.

4. An automated strike according to claim 1, wherein the strike plate comprises an aperture for receiving the latch.

5. An automated strike according to claim 1, wherein the mounting means comprises a back plate.

6. An automated strike according to claim 5, wherein the back plate comprises height adjustment means adapted to height adjust the automated strike in relation to the door jamb.

7. An automated strike according to claim 1, wherein the driving means is a solenoid.

8. An automated strike according to claim 1, wherein the driving means is a pneumatic cylinder or a spring.

9. A method for unlatching a sliding door comprising a latch and a strike plate comprising the steps of:
a. receiving a signal to unlatch the door;
b. activating driving means to slide the strike plate; and,
c. sliding the strike plate from a first position corresponding to a latched position to a second position corresponding to an unlatched position.

10. A method for unlatching a sliding door according to claim 9, further comprising the step of sliding the strike to a third position.

11. A method for unlatching a sliding door according to claim 9, wherein sliding the strike plate involves sliding an edge of an aperture in the strike plate over the latch.

12. A method for unlatching a sliding door according to claim 9, further comprising the step of driving the door in the closing direction to remove any pressure on the latch.

13. An automatic door package comprising a strike plate according to claim 1.

14. An automation kit for automating a manual sliding door package comprising a strike plate according to claim 1.
